(19) United States
(12) Patent Application Publication
(10) Pub. No.: US 2020/0402496 A1
(43) Pub. Date: Dec. 24, 2020

(54) REVERBERATION ADDING APPARATUS, REVERBERATION ADDING METHOD, AND REVERBERATION ADDING PROGRAM

(71) Applicant: Sony Corporation, Tokyo (JP)

(72) Inventor: Yuji Tsuchida, Kanagawa (JP)

(73) Assignee: Sony Corporation, Tokyo (JP)

(21) Appl. No.: 16/979,139

(22) PCT Filed: Jan. 8, 2019
(86) PCT No.: PCT/JP2019/000208

§ 371 Date: Sep. 8, 2020

(30) Foreign Application Priority Data
Mar. 15, 2018 (JP) 2018-047499

(51) Int. Cl. G10K 15/12; H04S 1/00

(52) U.S. Cl. CPC G10K 15/12; H04S 1/007

(57) ABSTRACT

A reverberation adding apparatus includes: a plurality of paths that constitutes an output channel or a plurality of output channels; and a convolution operation unit that convolves an impulse response for each of the paths, in which the impulse response is formed by combining a plurality of reverberation pattern blocks in a time axis direction, the reverberation adding apparatus using the reverberation pattern blocks common to the plurality of convolution operation units.

### TECHNICAL FIELD

The present disclosure relates to a reverberation adding apparatus, a reverberation adding method, and a reverberation adding program.

### BACKGROUND ART

Conventionally, an apparatus that reproduces various sound fields such as a concert hall by processing acoustic signals has been proposed. As shown in Patent Literatures 1 and 2, such an apparatus generally adds reverberation formed by sound reflection in the sound field.

### CITATION LIST

### Patent Literature

Patent Literature 1: Japanese Patent Application Laid-open No. HEI 6-269098
Patent Literature 2: Japanese Patent Application Laid-open No. 2003-157090

### DISCLOSURE OF INVENTION

### Technical Problem

In such fields, a large operation amount is required in order to realize reverberation with a high acoustic effect.

It is one of objects of the present disclosure to provide a reverberation adding apparatus, a reverberation adding method, and a reverberation adding program that reduce the operation amount in order to realize reverberation with a high acoustic effect.

### Solution to Problem

The present disclosure provides, for example, a reverberation adding apparatus, including: a plurality of paths that constitutes an output channel or a plurality of output channels; and a convolution operation unit that convolves an impulse response for each of the paths, in which the impulse response is formed by combining a plurality of reverberation pattern blocks in a time axis direction, the reverberation adding apparatus using the reverberation pattern blocks common to the plurality of convolution operation units.

The present disclosure provides, for example, a reverberation adding method including: performing a convolution operation process of convolving an impulse response in a plurality of paths that constitutes an output channel or a plurality of output channels; forming the impulse response by combining a plurality of reverberation pattern blocks in a time axis direction; and using the reverberation pattern blocks common to a plurality of convolution operation processes, the plurality of convolution operation processes each being the convolution operation process.

The present disclosure provides, for example, a reverberation adding program including: performing a convolution operation process of convolving an impulse response in a plurality of paths that constitutes an output channel or a plurality of output channels; forming the impulse response by combining a plurality of reverberation pattern blocks in a time axis direction; and using the reverberation pattern blocks common to a plurality of convolution operation processes, the plurality of convolution operation processes each being the convolution operation process.

### Advantageous Effects of Invention

In accordance with at least one embodiment of the present disclosure, it is possible to reduce the operation amount and realize reverberation with a high acoustic effect. The effects described herein are not necessarily limited and may be any of the effects described in the present disclosure. Further, the contents of the present disclosure are not to be construed as being limited by the illustrated effects.

### BRIEF DESCRIPTION OF DRAWINGS

FIG. 1 is a diagram for describing sound transfer paths in a given acoustic space.

FIG. 2 is a diagram for describing sound reflection in the given acoustic space.

FIG. 3 is a block diagram showing signal processing of a reverberation adding apparatus according to the present embodiment.

FIG. 4 is a block diagram showing the signal processing of the reverberation adding apparatus according to the present embodiment.

FIG. 5 is a block diagram showing signal processing with respect to a rear reverberation sound according to the present embodiment.

FIG. 6 is a diagram for describing reverberation pattern blocks constituted by impulse responses.

FIG. 7 is a diagram showing arrangement examples A and B of the reverberation pattern blocks.

FIG. 8 is a diagram showing arrangement examples C and D of the reverberation pattern blocks.

FIG. 9 is a diagram showing arrangement examples E and F of the reverberation pattern blocks.

FIG. 10 is a table showing a relationship between arrangement examples A to F of the reverberation pattern blocks and various conditions.

FIG. 11 is a block diagram describing a simplification process of the signal processing with respect to the rear reverberation sound according to the present embodiment.

FIG. 12 is a block diagram describing the simplification process of the signal processing with respect to the rear reverberation sound according to the present embodiment.

FIG. 13 is a block diagram describing the simplification process of the signal processing with respect to the rear reverberation sound according to the present embodiment.

FIG. 14 is a block diagram describing the simplification process of the signal processing with respect to the rear reverberation sound according to the present embodiment.

### MODE(S) FOR CARRYING OUT THE INVENTION

As one of use forms of the reverberation adding apparatus, an apparatus aimed at reproducing a sound field such as a listening room, a stadium, and a movie theater through signal processing is known. Such a technology is realized by convolving a binaural-room impulse response (BRIR) with a signal of the sound source with respect to the signal of the sound source. The BRIR is obtained by convolving a room impulse response (RIR) that is an impulse response from a sound source position (speaker or the like) to a listening position in the sound field with a head-related impulse response (HRIR) of a listener.

Each of the RIR and the HRIR is individually by determined by means such as measurement and acoustic simulation, and then the BRIR can be obtained by convolving them through a calculation process. Further, other than such means, there is also a method of directly measuring the BRIR by the use of a dummy head in a sound field wished to be reproduced.

A reverberation time of the sound field wished to be realized through those means is, for example, about 0.5 seconds in a listening room suitable for music listening and 1 second or more in a concert hall or a stadium. In order to reproduce such reverberation by signal processing, the BRIR has a duration of about 26000 samples at a sampling frequency of 44.1 kHz.

Further, in a case where a two-channel sound source is used as an input signal as in stereo, since there is a BRIR for a total of four transmission paths that are respectively combined with two output channels, the convolution processing of the BRIR of about 26000 samples needs to be performed four times in a case of performing the above-mentioned signal processing.

Conventionally, it has been difficult to realize digital signal processing of such a size by CPUs and DSPs of embedded devices having limited computing capabilities, and simple measures such as shortening the BRIR to reduce the computational complexity of convolution, or generating rear reverberation sounds by using autoregressive filters have been taken.

However, when the BRIR is shortened, there is a disadvantage that the reverberation effect cannot be sufficiently obtained, and it has been difficult to overcome an echo-like sound quality disadvantage derived from the autoregressive filter in a case of using an autoregressive filter or a disadvantage that the coloration inherent in the frequency response is made.

The BRIR is roughly divided into three in view of the sound wave transfer path (transfer time elapse): (1) direct wave; (2) early reflected sound; and (3) rear reverberation sound.

As the direct wave of (1), the sound reproduced from the speaker reaches the sound receiving point directly without experiencing processes such as reflection and diffusion.

As the early reflected sound of (2), the sound reproduced from the speaker is reflected one or two times at an acoustic interface such as a floor, a ceiling, and a wall and reaches the sound receiving point relatively early, and since the acoustic transmission path is simple and short, the arrival direction and the delay time with respect to the direct wave of (1) strongly reflect the characteristics such as the shape of the sound field.

As the rear reverberation sound of (3), the sound reaches the receiving point relatively late after it experiences reflection and diffusion at the acoustic interface a plurality of times, as the shape of the acoustic boundary surface and the distribution of the sound absorption rate is devised to be suitable for music listening space, the time and arrival direction of the reflected wave approaches a random phenomenon, and there is a tendency that the density of the reaching reverberation also increases.

For this reason, an impulse excellent in the sound quality can be formed in accordance with a method of generating the rear reverberation sound of the BRIR by using pseudorandom numbers on the basis of statistical parameters reflecting the acoustic characteristics of the sound field (e.g., reverberation time, reverberation frequency characteristics, and the like).

In the present disclosure, a method of forming an impulse response by using the pseudorandom numbers on the basis of the statistical parameters is employed in generation of the rear reverberation sound (also simply referred to as “reverberation sound”). First of all, premises of a reverberation adding apparatus 1 to be used in the present embodiment will be described.

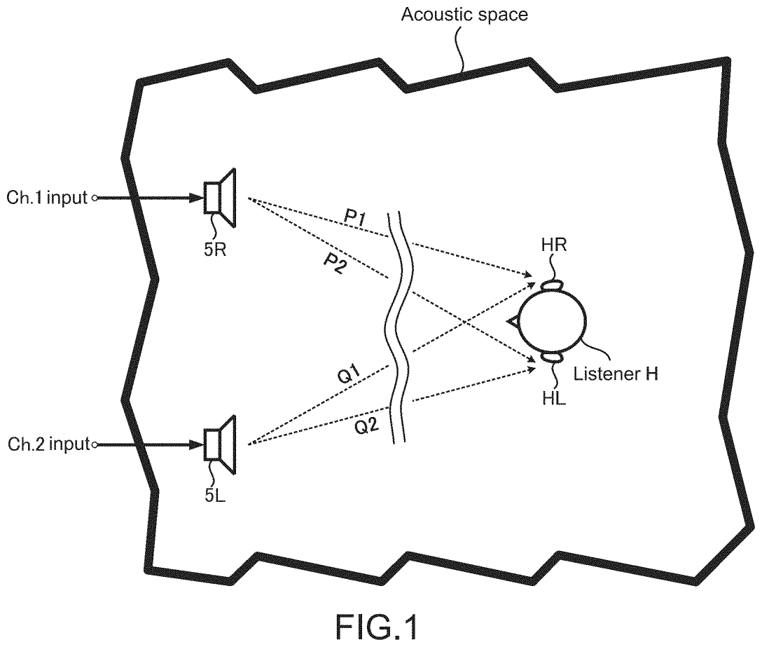

FIG. 1 is a diagram for describing sound transfer paths in a case where two-channel speakers 5R and 5L are used as sound sources in a given acoustic space. Although many paths connecting the sound sources (the speakers 5R and 5L) and sound receiving points (the ears HR and HL) exist in the actual acoustic space, those can be aggregated as four combinations of transfer paths (P1, P2, Q1, and Q2) connecting between the sound source (the speakers 5R and 5L) and the sound receiving point (the ears HR and HL) by using four transfer functions in signal processing.

As described above, the method of synthesizing the rear reverberation sound portion in the impulse response by using the pseudorandom numbers on the basis of the statistical parameters is used in the present embodiment. In this method, the generation times, the generation directions, and the generation intensities of the reflected sounds are generated using pseudo-random numbers having suitable distributions respectively, and a BRIR is synthesized by obtaining HRIR_ch1, which is an HRIR on the left ear side, and HRIR_ch2, which is an HRIR on the right ear side, from a database of the head-related impulse response (HRIR) of the listener. It should be noted that those statistical parameters having the distributions are adjusted to provide desired sound quality. Further, besides the generation times, the generation directions, and the generation intensities, other elements such as frequency characteristics of each reflected sound of the reflected sounds may also be generated in accordance with a statistical method in a manner that depends on needs.

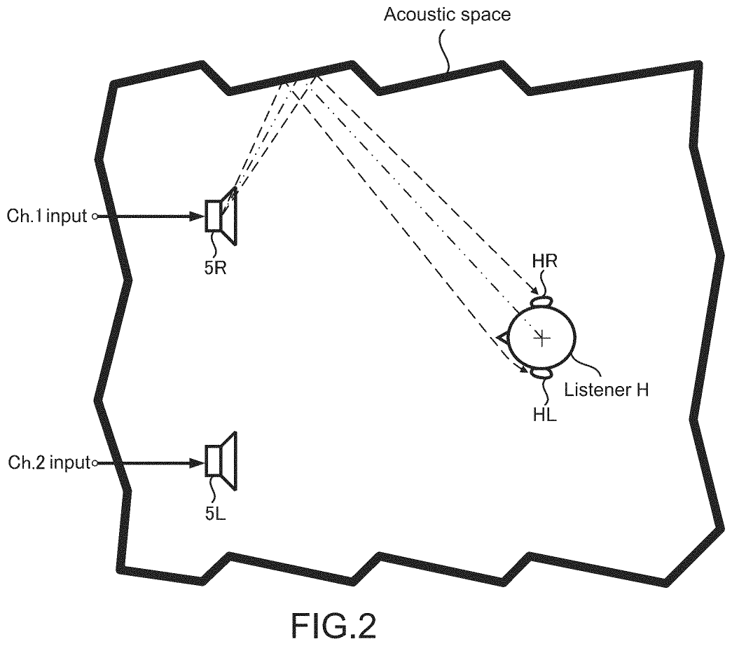

Here, the impulse response of the rear reverberation sound of each path has the following characteristics. In FIG. 1, the reverberation sounds of the path P1 and the path P2 or the path Q1 and the path Q2 often pass through geometrically relatively similar paths as shown in FIG. 2 (shown as a single reflection for the sake of simplification, and the same applies to the rear reverberation sound which experience multiple reflections), and thus the generation time, the generation direction, and the generation intensity of the rear reverberation sound are also similar, and a relatively strong correlation is established between impulse responses of the path P1 and the path P2 or the path Q1 and the path Q2 as a result. On the other hand, the rear reverberation sounds of the path P1 and the path Q1 or the path P1 and the path Q2, the path P2 and the path Q1, the path P2 and the path Q2 respectively pass through different transfer paths, and thus substantially no correlation is established between the impulse responses of them. When generating the rear reverberation sounds using the pseudorandom numbers, the sound image localization effect can be further enhanced by reproducing the feature of such correlation between the paths.

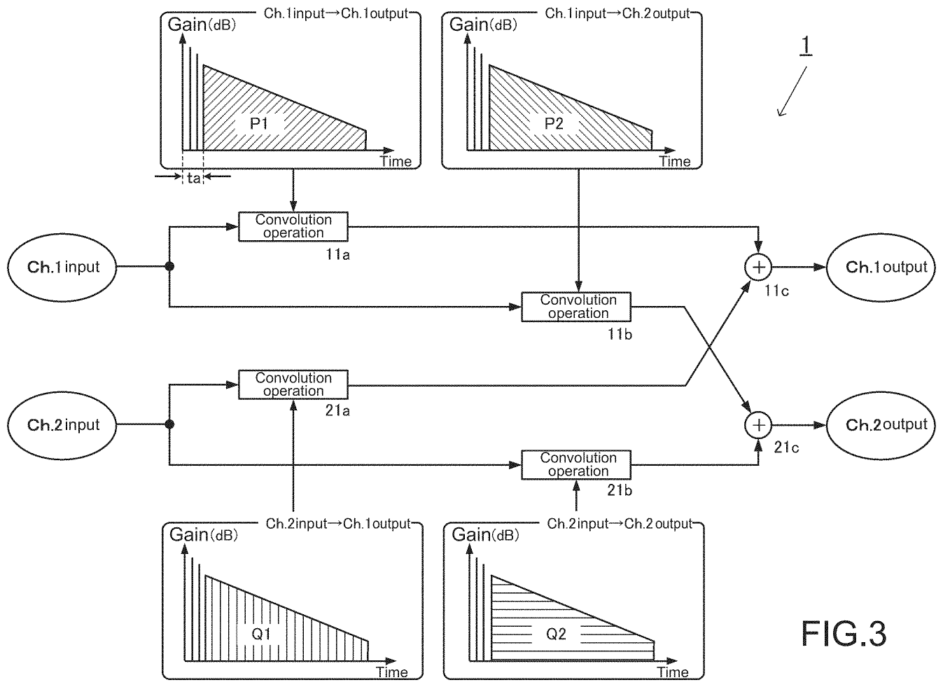

FIG. 3 a block diagram showing signal processing of the reverberation adding apparatus 1 according to the present embodiment and is a block diagram corresponding to transfer paths in the sound field space of FIG. 1. First of all, formation of a first output channel, i.e., a sound that a listener H hears from the right ear will be described. It should be noted that schematic diagrams of impulse responses to be convoluted are shown in respective convolution operation units 11a to 21b.

The convolution operation unit 11a performs a convolution operation of convoluting an impulse response P1 simulating the path P1 on an acoustic signal input from a first input channel and outputs it to an adder 11c. The convolution operation unit 21a performs a convolution operation of convoluting an impulse response Q1 simulating the path Q1 on an acoustic signal input from a second input channel and outputs it to the adder 11c. The adder 11c adds up the outputs of the convolution operation unit 11a and the convolution operation unit 21a and outputs it as the first output channel.

The same applies to formation a second output channel, i.e., a sound that the listener H hears from the left ear. The convolution operation unit 11b performs a convolution operation of convoluting an impulse response P2 simulating the path P2 on an acoustic signal input from a second input channel and outputs it to an adder 21c. The convolution operation unit 21b performs a convolution operation of convoluting an impulse response Q2 simulating the path Q2 on an acoustic signal input from a second input channel and outputs it to the adder 21c. The adder 21c adds up the outputs of the convolution operation unit 11b and the convolution operation unit 21b and outputs it as the first output channel.

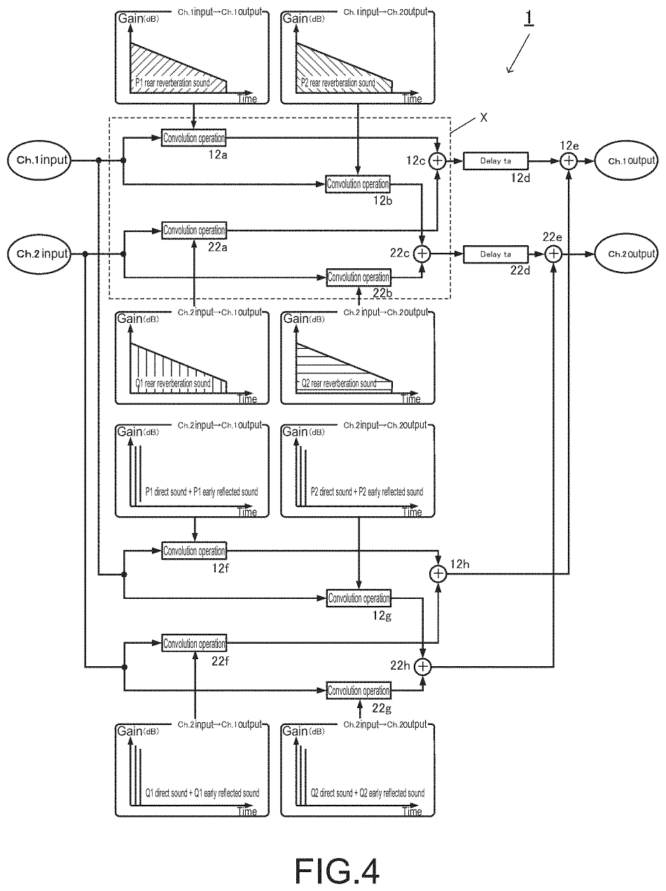

FIG. 4 is a block diagram in which the signal processing of the reverberation adding apparatus 1 described with respect to FIG. 3 is divided into signal processing with respect to the direct sound and the early reflected sound and signal processing with respect to the reverberation sound. As shown in the schematic diagram of the impulse response corresponding to the convolution operation unit 11a in FIG. 3, the rear reverberation sound is started, delayed by a time to from the start. The same applies to the other convolution operation units 11b, 12a, and 12b, and the impulse response can be divided into two types of signal processing by replacing this delay time ta by another one through a delay unit 12d or 22d.

First of all, formation of the rear reverberation sound will be described. The convolution operation unit 12a performs a convolution operation related to the rear reverberation sound in the impulse response P1 of the convolution operation unit 11a of FIG. 3. The convolution operation unit 12b performs a convolution operation related to the rear reverberation sound in the impulse response P2 of the convolution operation unit 11b of FIG. 3. The convolution operation unit 22a performs a convolution operation related to the rear reverberation sound in the impulse response Q1 of the convolution operation unit 21a of FIG. 3. The convolution operation unit 22b performs a convolution operation related to the rear reverberation sound in the impulse response Q2 of the convolution operation unit 21b of FIG. 3.

By adding up the outputs of the convolution operation unit 12a having the first input channel as an input and the convolution operation unit 22a having the second input channel as an input through an adder 12c and then delaying it by the time ta through the delay unit 12d, the rear reverberation sound of the first output channel is formed.

By adding up the outputs of the convolution operation unit 12b having the first input channel as an input and the convolution operation unit 22b having the second input channel as an input through the adder 22c and then delaying the time to through the delay unit 22d, the rear reverberation sound of the second output channel is formed.

Next, formation of the direct sound and the early reflected sound will be described. The convolution operation unit 12f performs a convolution operation related to the direct sound and the early reflected sound in the impulse response P1 of the convolution operation unit 11a of FIG. 3. The convolution operation unit 12g performs a convolution operation related to the direct sound and the early reflected sound in the impulse response P2 of the convolution operation unit 11b of FIG. 3. The convolution operation unit 22f performs a convolution operation related to the direct sound and the early reflected sound in the impulse response Q1 of the convolution operation unit 21a of FIG. 3. The convolution operation unit 22g performs a convolution operation related to the direct sound and the early reflected sound in the impulse response Q2 of the convolution operation unit 21b of FIG. 3.

By adding up the outputs of the convolution operation unit 12f having the first input channel as an input and the convolution operation unit 22f having the second input channel as an input through the adder 12h, the direct sound and the early reflected sound of the first output channel are formed.

By adding up the outputs of the convolution operation unit 12g having the first input channel as an input and the convolution operation unit 22g having the second input channel as an input through an adder 22h, the direct sound and the early reflected sound of the second output channel are formed.

By adding up the rear reverberation sound of the first output channel (the output of the delay unit 12d) and the direct sound and the early reflected sound of the first output channel, which have been obtained in the above-mentioned signal processing, through an adder 12e, the acoustic signal of the first output channel can be obtained.

Then, by adding up the rear reverberation sound of the second output channel (the output of the delay unit 22d) and the direct sound and the early reflected sound of the second output channel through an adder 22e, the acoustic signal of the second output channel can be obtained.

The present embodiment is characterized by the generation of the rear reverberation sounds. In the following description, the generation of the rear reverberation sounds will be described.

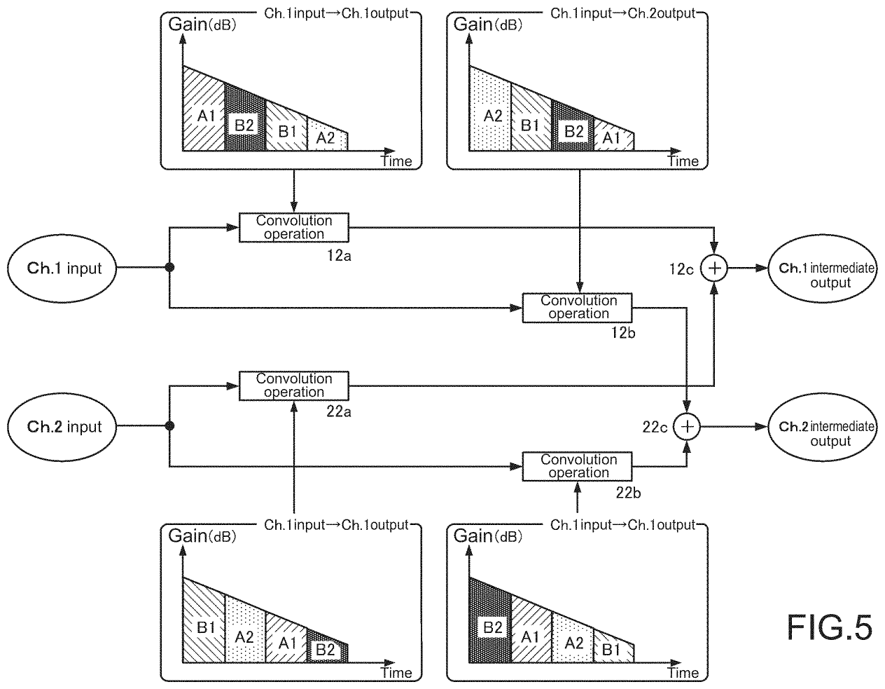

FIG. 5 is a block diagram obtained by extracting a portion where a characteristic convolution operation in the generation of the rear reverberation sounds is performed in the block diagram of FIG. 4, and just corresponds to the portion in the broken line rectangle X in FIG. 4.

In the present embodiment, the impulse responses for forming the rear reverberation sound are formed by a combination of a plurality of (in the present embodiment, four) reverberation pattern blocks arranged in the time series order and the reverberation pattern blocks are shared with the convolution operation units 12a, 12b, 22a, and 22b arranged on the plurality of paths. Here, the reverberation pattern blocks are constituted by a train of impulse responses arranged in a time axis direction and are calculated by adding random elements in consideration of a sound source position set by the reverberation adding apparatus 1, a listener position, and a sound field environment (sound field environment information regarding the shape and area of the sound field, the material of the wall surface, and the like).

In the present embodiment, in FIG. 5, in the respective convolution operation units 12a, 12b, 22a, and 22, reverberation pattern blocks A1, A2, B1, and B2 positioned at the heads of the respective impulse responses are calculated by using the method of synthesizing on the basis of the above-mentioned statistical parameters with the pseudorandom numbers. Then, by combining them and arranging them in the time series, the respective impulse responses are formed in the respective convolution operation units 12a, 12b, 22a, and 22. Therefore, only calculation of the reverberation pattern blocks A1, A2, B1, and B2 is required, and the operation amount for forming the impulse responses can be thus reduced.

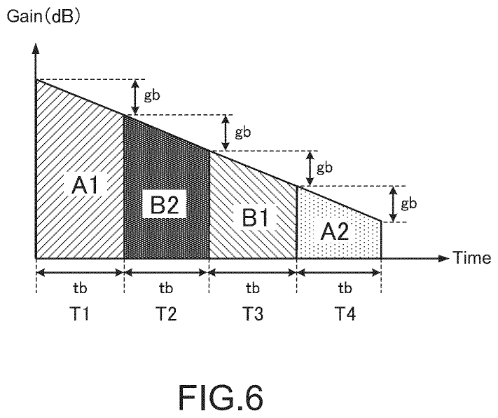

FIG. 6 is a diagram showing an impulse response of the convolution operation unit 12a in FIG. 5. By exemplifying this impulse response, the reverberation pattern blocks will be described. The respective reverberation pattern blocks A1, A2, B1, and B2 in the present embodiment have a common time duration tb and are arranged to be adjacent to adjacent time slots T1 to T4. Further, the adjacent reverberation pattern blocks A1, A2, B1, and B2 have a scale factor of an attenuation coefficient gb therebetween. As described above, in each convolution operation unit 12a, 12b, 22a, and 22b, the reverberation pattern block A1, A2, B1, or B2 positioned at the head is calculated. Therefore, in FIG. 6, the reverberation pattern block B2 positioned at the time slot T2 can be easily obtained by multiplying the reverberation pattern block B2 positioned at calculated head with the attenuation coefficient gb. Further, the reverberation pattern block B1 positioned at the time slot T3 can be obtained by multiplying the calculated reverberation pattern block B1 with a attenuation coefficient 2×gb. Further, the reverberation pattern block A2 positioned at the time slot T4 can be obtained by multiplying the calculated reverberation pattern block A2 with a attenuation coefficient 3×gb.

It should be noted that although in the present embodiment, the reverberation pattern block is the predetermined time duration tb and applied to each of the time slots T1 to T4, it is sufficient to commonly use the reverberation pattern blocks among the convolution operation units 12a, 12b, 22a, and 22b and it is not necessarily necessary to set the reverberation pattern block to be the predetermined time duration or to apply the reverberation pattern block to each of the time slots T1 to T4. It should be noted that favorably, it is favorable that the common reverberation pattern blocks are set to be different in use time position between the convolution operation units 12a, 12b, 22a, and 22b.

Further, in the present embodiment, the reverberation pattern block is the predetermined time duration tb and the impulse response exponentially attenuates, and it is assumed that the vertical axis indicates dB (logarithmic notation), the attenuation coefficient gb is multiplied. However, it is sufficient that the reverberation pattern block to be reused is multiplied by the coefficient depending on the use time position, and nonlinear attenuation may be considered. Further, it is not necessarily necessary to calculate one positioned at the head of the impulse response as the reverberation pattern block, and it is also possible to calculate the reverberation pattern block positioned at an appropriate position.

As described above, in the present embodiment, regarding the impulse responses arranged on the paths that constitute a plurality of output channels, the impulse responses are formed by combining the plurality of reverberation pattern blocks in the time axis direction. Further, the reverberation pattern blocks common to the plurality of convolution operation units are used. Thus, reverberation with a high acoustic effect can be formed with the operation amount reduced.

Next, a favorable form of arrangement of the reverberation pattern blocks will be described. The reverberation pattern blocks can realize reverberation with a high acoustic effect by satisfying four conditions described below. As the number of satisfied conditions becomes larger, the acoustic effect of the reverberation and the reduction effect of the operation amount are enhanced.

(First Condition)

The first condition is that the impulse responses used in the plurality of convolution operation units 12a, 12b, 22a, and 22b arranged on the paths that respectively constitute the identical output channels have common permutations of the reverberation pattern blocks. It should be noted that it is favorable that those permutations are different in use time position between the convolution operation units 12a, 12b, 22a, and 22b. For example, in FIG. 5, the convolution operation units 12a and 22a arranged on the paths that constitute a first intermediate output channel are constituted by the permutations A1 and B2 and the permutations B1 and A2 of the reverberation pattern blocks. Similarly, the convolution operation units 12b and 22b arranged on the paths that constitute a second intermediate output channel are constituted by the permutations A2 and B1 and the permutations B2 and A1 of the reverberation pattern blocks. That is, it is the form in which the first condition is satisfied.

By satisfying the first condition as described above, the convolution operation can be simplified and the operation amount can be reduced. The form in which the operation amount is reduced will be described later in detail. It should be noted that although the permutation of the reverberation pattern blocks is a sequence of the two reverberation pattern blocks in the example of FIG. 5, it is also possible to set the permutation to be a sequence of three or more reverberation pattern blocks in a case where the impulse response is formed of five or more reverberation pattern blocks for example.

(Second Condition)

The second condition is that the same plurality of reverberation pattern blocks is not used in one impulse response used in each of the convolution operation units 12a, 12b, 22a, and 22b and the same reverberation pattern blocks are not temporally adjacent in the one impulse response. For example, in FIG. 5, in the impulse response of any of the convolution operation units 12a, 12b, 22a, and 22b, the same plurality of reverberation pattern blocks is not used and the same reverberation pattern blocks are not temporally adjacent. Therefore, the example of FIG. 5 is in the form satisfying the second condition.

In a case where the second condition is not satisfied, it is conceivable that the reverberation pattern blocks are repeatedly convoluted with respect to the input acoustic signal and echo-like sound quality degradation occurs. By satisfying the second condition, the correlation between the repeated portions is reduced, such that the occurrence of the echo-like sound quality degradation can be avoided or the echo-like sound quality degradation can be alleviated.

(Third Condition)

In the example of FIG. 5, the specification in the stereo form in which the two input channels that are the first and second input channels are provided is employed. However, it is also possible to employ a mono form in which the first and second input channels are the same input. The third condition is that the same reverberation pattern blocks are prevented from being temporally adjacent in an addition result in a case where the impulse responses are added between the convolution operation units provided on the plurality of paths that constitutes the identical output channel.

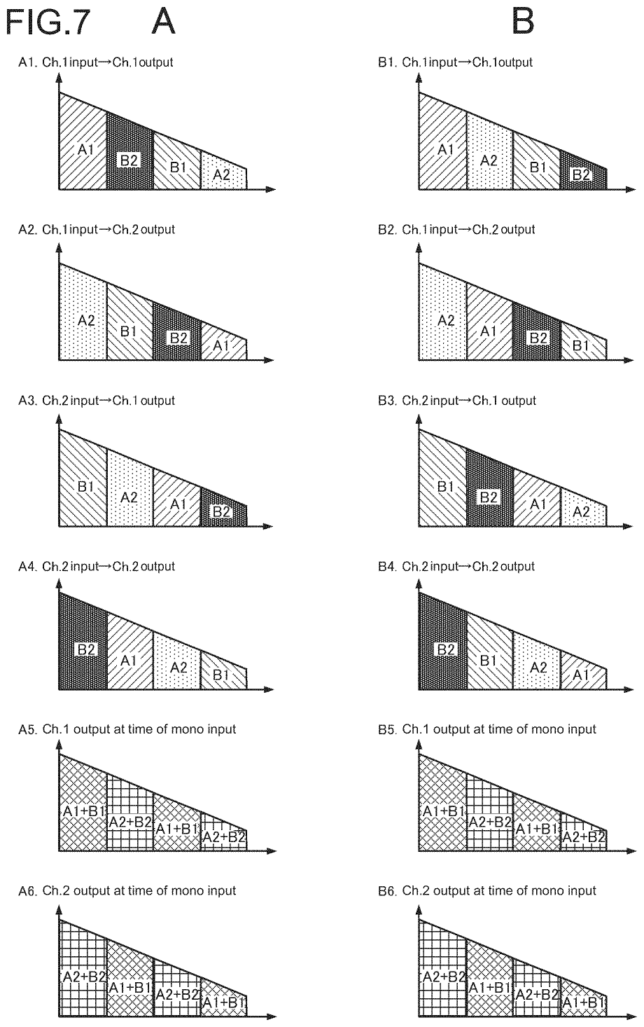

A1 of FIG. 7 to A4 of FIG. 7 are diagrams showing arrangement examples of the reverberation pattern blocks in the example of FIG. 5. A5 of FIG. 7 shows an impulse response at the time of output of the first input channel at the time of mono input, i.e., an impulse response obtained by adding up the impulse responses of the convolution operation unit 12a and the convolution operation unit 22a in FIG. 5. Further, A6 of FIG. 7 is an impulse response at the time of output of the second input channel at the time of mono input, i.e., an impulse response obtained by adding up the impulse responses of the convolution operation unit 12b and the convolution operation unit 22b in FIG. 5. As can be seen from A5 of FIG. 7 and A6 of FIG. 7, both are in the form in which “A1+B1” and “A2+B2” are alternately arranged in the reverberation pattern blocks. That is, it is the form satisfying the third condition.

By satisfying the third condition, the repeated portions in which the same reverberation pattern blocks are convoluted is prevented from being generated, such that the occurrence of the echo-like sound quality degradation can be avoided or the echo-like sound quality degradation can be alleviated. This third condition is particularly effective in a case where the input is in the mono form, though it effectively acts also in the stereo form.

(Fourth Condition)

In the example of FIG. 5, the reverberation pattern block A1, A2, B1, or B2 positioned at the head of the impulse response is calculated by using the method of synthesizing with the pseudorandom number on the basis of the statistical parameter as described above. Here, in FIG. 1, the reverberation pattern block A1 corresponds to the path P1, the reverberation pattern block A2 corresponds to the path P2, the reverberation pattern block B1 corresponds to the path Q1, and the reverberation pattern block B2 corresponds to the path Q2. As described above, in the method of synthesizing with the pseudorandom number on the basis of the statistical parameter, a relatively strong correlation is established between the impulse responses of the path P1 and the path P2 or the path Q1 and the path Q2. Therefore, a strong correlation is also established between the reverberation pattern blocks A1 and A2 or B1 and B2.

Under the fourth condition, in a case where a plurality of output channels is provided and the output channels have a plurality of paths having the identical input channel as the input, a combination of the reverberation pattern blocks to be used at the same use time position is in a predetermined relationship in impulse responses of the convolution operation units provided on the plurality of paths having the identical input channel as the input.

For example, in FIG. 5, referring to the impulse responses of the convolution operation units 12a and 12b arranged on the paths that constitute the first input channel, a combination of “A1, A2”, “B2, B1”, “B1, B2”, and “A2, A1” with “A1, A2” calculated with respect to the first input channel or “B1, B2” calculated with respect to the second input channel is shown. Also, referring to the impulse responses of the convolution operation units 22a and 22b arranged on the paths that constitute the second input channel, a combination of “B1, B2”, “A2, A1”, “A1, A2”, and “B2, B1” with “A1, A2” calculated with respect to the second input channel or “B1, B2” calculated with respect to the second input channel is shown. Therefore, the example of FIG. 5 shows the form satisfying the fourth condition.

By satisfying the fourth condition, when convolving a plurality of reverberation pattern blocks at the same time position with respect to an acoustic signal input into a certain input channel, reverberation pattern blocks calculated having a correlation therebetween are convolved, and the acoustic effect, in particular, the sound image localization effect can be kept high.

Hereinabove, the first to fourth conditions have been described, though it is not necessarily necessary to satisfy all those conditions. By increasing the number of satisfied conditions of those conditions, the acoustic effect and the reduction effect of the operation amount when adding the reverberation can be enhanced.

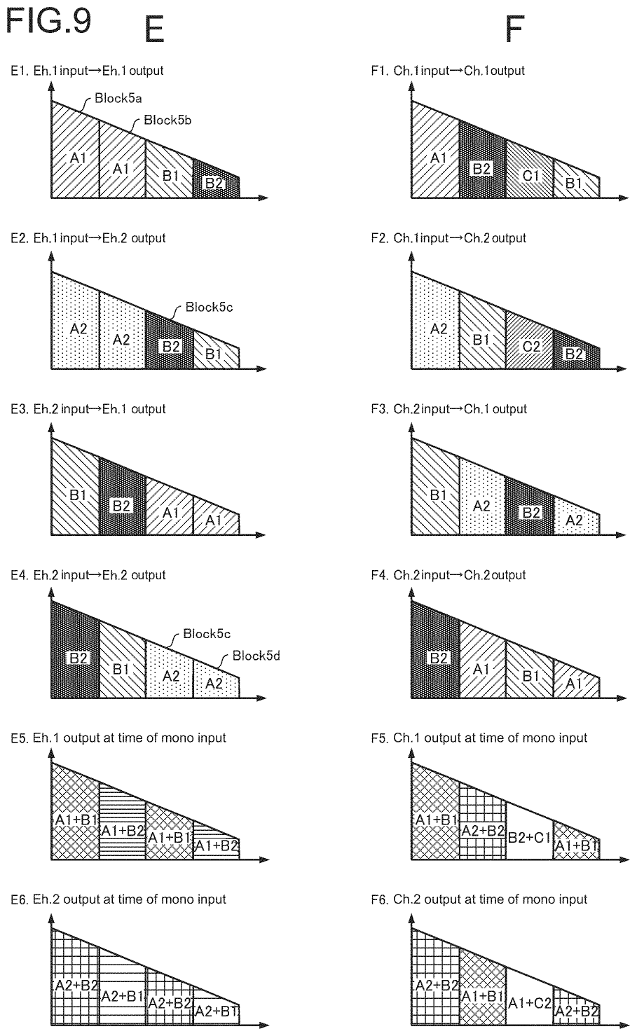

FIG. 7 to FIG. 9 are diagrams each showing arrangement examples A to F of the reverberation pattern blocks. A of FIG. 7 is the arrangement example A of the reverberation pattern blocks and corresponds to the arrangement examples described with reference to FIG. 5. A1 of FIG. 7 is the impulse pattern of the convolution operation unit 12a, A2 of FIG. 7 is the impulse pattern of the convolution operation unit 12b, A3 of FIG. 7 is the impulse pattern of the convolution operation unit 22a, and A4 of FIG. 7 is the impulse pattern of the convolution operation unit 22b. Further, A5 of FIG. 7 is the impulse response in a case where the mono input is employed in FIG. 5, i.e., where the impulse responses of the convolution operation unit 12a and the convolution operation unit 22a are added up. Further, A6 of FIG. 7 is the impulse response in a case where the mono input is employed in FIG. 5, i.e., where the impulse responses of the convolution operation unit 12b and the convolution operation unit 22b are added up.

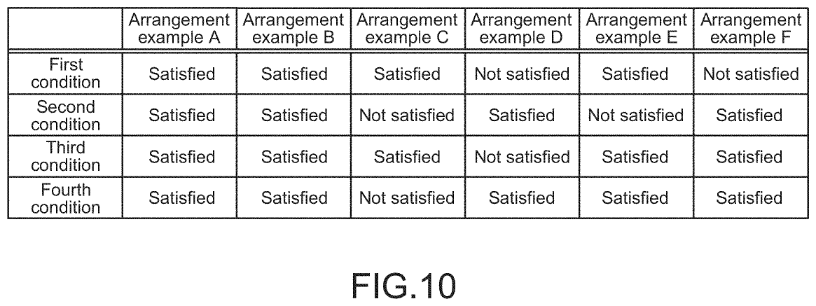

The same applies to the other arrangement examples B to F and FIG. 10 shows a relationship between those arrangement examples A to F and the first to fourth conditions. Regarding the arrangement example A, it is the form satisfying all the conditions as described above together with the description of the first to fourth conditions. Also regarding the arrangement example B, it is the form satisfying all the conditions.

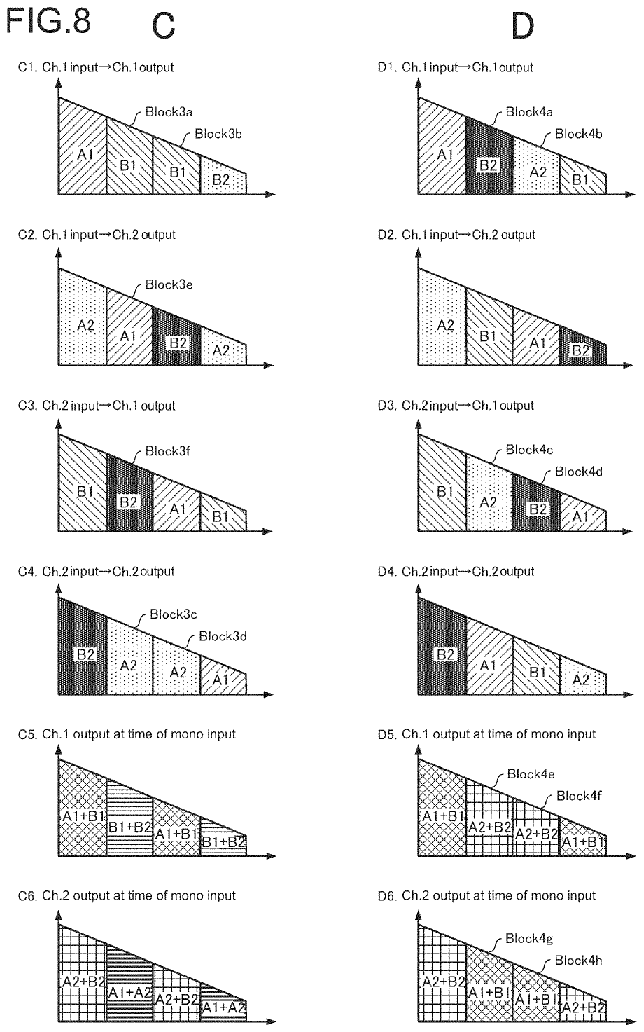

In view of the arrangement example C, Block 3a and Block 3b are the same reverberation pattern blocks and Block 3c and Block 3d are the same reverberation pattern blocks in C1 of FIG. 8, and thus the condition 2 is not satisfied. Further, in C2 of FIG. 8, Block 3a (reverberation pattern block B1) and Block 3e (reverberation pattern block A1) are the reverberation pattern blocks with respect to the first input channel but those are the reverberation pattern blocks having no correlation therebetween, and thus the fourth condition is not satisfied. In C2 of FIG. 8, also regarding Block 3f (reverberation pattern block B2) and Block 3c (reverberation pattern block A2), the fourth condition is not satisfied.

Regarding the arrangement example D, in view of two diagrams of D1 of FIG. 8 and D3 of FIG. 8 in D of FIG. 8, those two impulse responses are constituted by identical reverberation pattern blocks. However, in view of the arrangement of the reverberation pattern blocks, there are no portions constituted by common permutations (here, sequences of two reverberation pattern blocks). Therefore, the first condition is not satisfied. Further, as shown in D5 of FIG. 8, in a case of employing the mono input, Block 4e and Block 4f are temporally consecutive, and thus the third condition is not satisfied. Also in D6 of FIG. 8, Block 4g and Block 4h are temporally consecutive, and thus the third condition is not satisfied.

In view of the arrangement example E, the same reverberation pattern blocks A1 are temporally consecutive in Block 5a and Block 5b in μl of FIG. 8, for example. Therefore, the point that the same plurality of reverberation pattern blocks are not used in one impulse response and the point that the same reverberation pattern blocks are not temporally adjacent are not satisfied, and the second condition is not satisfied. Also in Block 5c and Block 5d in E4 of FIG. 8, the same reverberation pattern blocks A2 are temporally consecutive, and thus the second condition is not satisfied.

Unlike the arrangement examples A to E, the arrangement example F is an example in which the reverberation pattern blocks C1 and C2 other than the reverberation pattern blocks A1, A2, B1, and B2 positioned at the head are used. In this manner, the reverberation pattern blocks C1 and C2 may be provided beyond the number of convolution operation units 12a, 12b, 22a, and 22b arranged on the paths. By increasing the number of reverberation pattern blocks, the degree of freedom in arrangement can be improved. The arrangement example F is an example in which the second to fourth conditions are satisfied but the first condition is not satisfied.

Next, the effect relating to the first condition regarding the arrangement of the reverberation pattern blocks, i.e., the point that the impulse responses used in the plurality of convolution operation units 12a, 12b, 22a, and 22b arranged on the paths that respectively constitute the identical output channels have the common permutations of the reverberation pattern blocks will be described. In a case where this first condition is satisfied, convolution operations can be unified and the operation amount can be reduced.

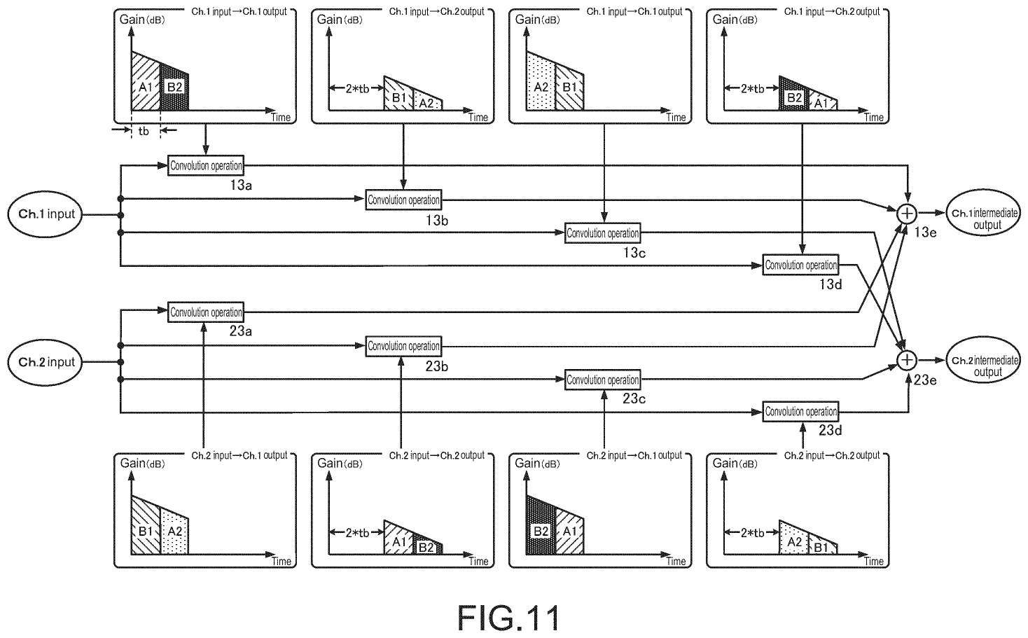

FIG. 11 to FIG. 14 are block diagrams each describing a simplification process of the signal processing with respect to the rear reverberation sound according to the present embodiment and correspond to the arrangement examples of the reverberation pattern blocks in FIG. 5. As described above, the arrangement of the reverberation pattern blocks in FIG. 5 satisfies the first condition.

FIG. 11 shows the form in which the convolution operation units are divided such that each impulse response in FIG. 5 is divided into a first part and a second part. For example, the convolution operation unit 12a in FIG. 5 is divided into the convolution operation units 13a and 13b in FIG. 11. It should be noted that in the convolution operation unit 13b, a delay time 2*tb corresponding to the first part is provided in order to convolve the impulse response positioned at the second part. The same applies to the other convolution operation units 12b, 22a, and 22b, and the convolution operation unit 12b corresponds to the convolution operation units 13c and 13d, the convolution operation unit 22a corresponds to the convolution operation units 23a and 23b, and the convolution operation unit 22b corresponds to the convolution operation units 23c and 23d. Calculation results of the convolution operation units 13a, 13b, 23a, and 23b are added up by the adder 13e. Further, calculation results of the convolution operation units 13c, 13d, 23c, and 23d are added up by the adder 23e.

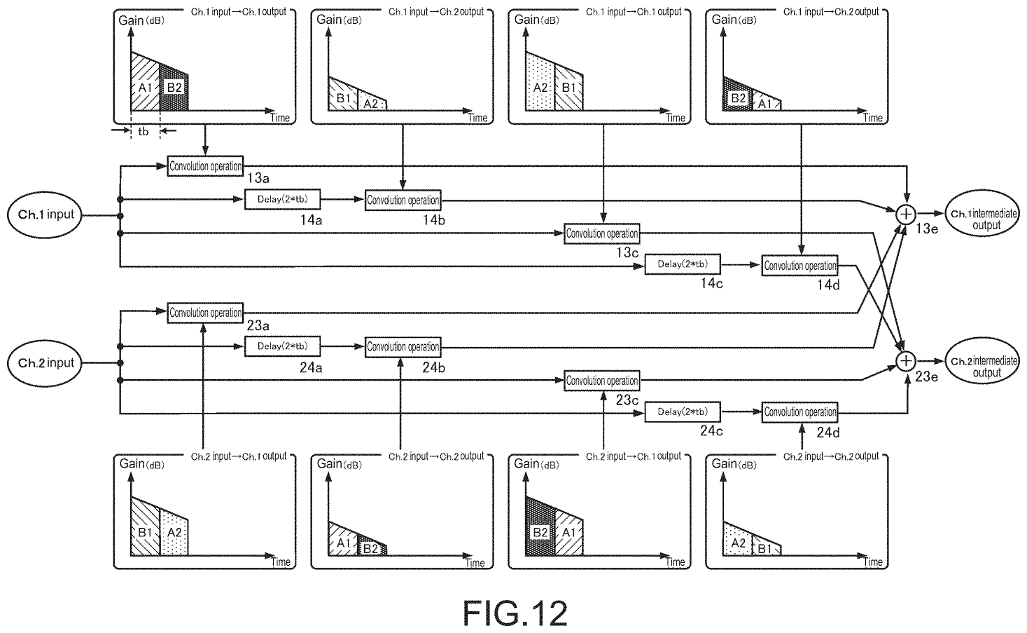

In FIG. 12, the impulse response positioned at the second part in FIG. 11 is convolved and the delay time 2*tb of the convolution operation unit 13b, 13d, 23b, or 23d is replaced by a delay unit 14a, 14c, 24a, or 24c. Therefore, the convolution operation units 14b, 14d, 24b, and 24d are not provided with the delay time unlike FIG. 11.

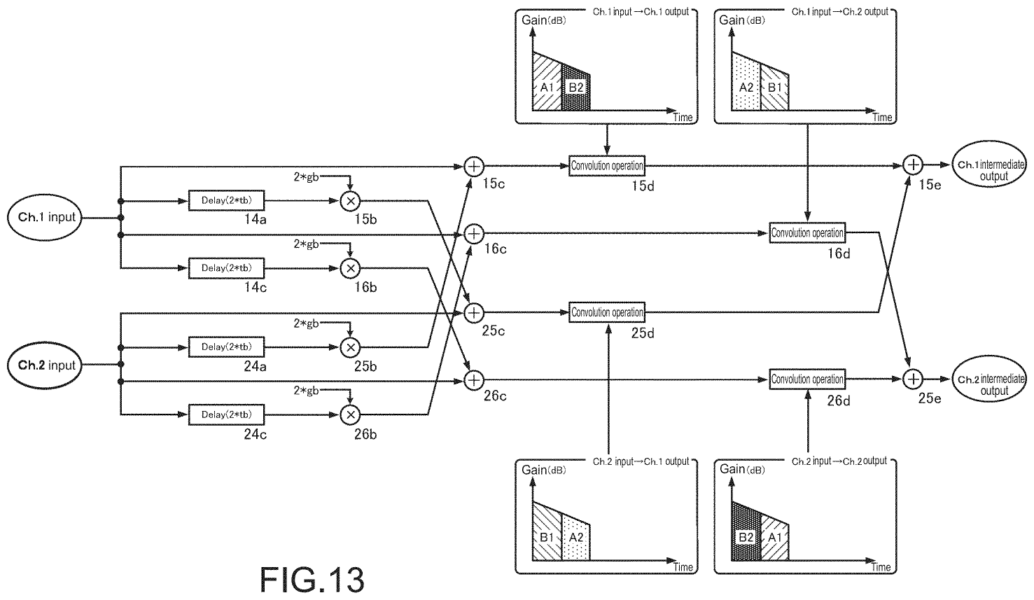

The arrangement examples described with reference to FIG. 5 satisfies the first condition and have the common permutations of the reverberation pattern blocks. For example, in FIG. 12, the permutations A1 and B2 of the reverberation pattern blocks to be convoluted at the convolution operation unit 13a are different in gain but those are common to the permutations A1 and B2 of the reverberation pattern blocks to be convoluted at the convolution operation unit 24b. Focusing on such common characteristics of the permutations of the reverberation pattern blocks, FIG. 13 shows the form in which the convolution operation units are unified. At this time, considering the gain difference, the second part of the impulse response is multiplied by the coefficient (attenuation coefficient) of 2*gb at the multiplier 25b. Here, as described with reference to FIG. 6, the coefficient gb is the attenuation coefficient corresponding to a difference for one time slot. The second part of the impulse response has the delay time of 2*tb relative to the first part, and thus the second part can be reproduced by multiplying the first part with a coefficient 2*gb corresponding to 2*tb.

In FIG. 12, the convolution operation unit 14b and the convolution operation unit 23a are common in that the permutations of the reverberation pattern blocks B1 and A2 are convolved. In FIG. 13, the convolution operation unit 14b and the convolution operation unit 23a are unified by using the convolution operation unit 25d, the multiplier 15b, and the adder 25c.

In FIG. 12, the convolution operation unit 13c and the convolution operation unit 24d are common in that the permutations of the reverberation pattern blocks A2 and B1 are convolved. In FIG. 13, the convolution operation unit 13c and the convolution operation unit 24d are unified by using the convolution operation unit 16d, the multiplier 26b, and the adder 16c.

In FIG. 12, the convolution operation unit 14d and the convolution operation unit 23c are common in that the permutations of the reverberation pattern blocks B2 and A1 are convolved. In FIG. 13, the convolution operation unit 14d and the convolution operation unit 23c are unified by using the convolution operation unit 26d, the multiplier 16b, and the adder 26c.

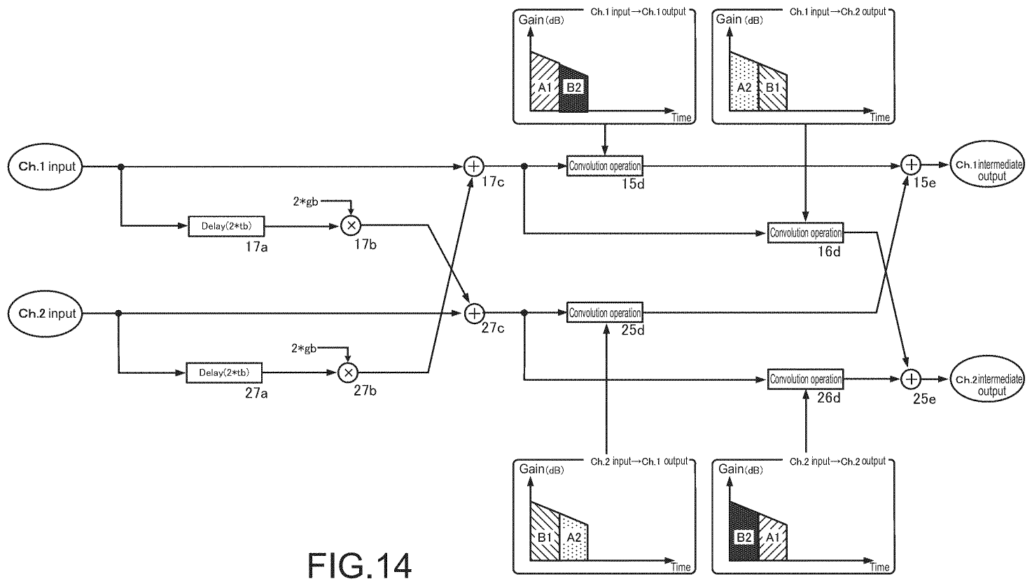

In FIG. 13, it can be seen that the delay units 14a and 14c that delay the first input channel and the multipliers 15b and 16b that multiply the first input channel by the coefficient 2*tb are common. Similarly, it can be seen that the delay units 24a and 24c that delay the second input channel and the multipliers 25b and 26b that multiply the second input channel by the coefficient 2*tb are common. In FIG. 14, with respect to the first input channel for example, those are unified by using the delay unit 17a, the multiplier 17b, and the adder 17c. Further, with respect to the second input channel, those are unified by using the delay unit 27a, the multiplier 27b, and the adder 27c.

The impulse response convolution shown in FIG. 5 is changed into the simplified impulse response convolution as shown in FIG. 14 by satisfying the first condition as described with reference to FIG. 11 to FIG. 14, and the operation amount can be thus reduced.

The reverberation adding apparatus according to the present embodiment can be used for various acoustic apparatuses for simulating the sound field. For the acoustic apparatuses, it is conceivable to employ a form in which an acoustic signal which is a simulation result is emitted from a speaker for causing a user to listen to it or a form in which an acoustic signal is emitted from a headphone worn by a user for causing a user to listen to it. As described with reference to FIG. 1, since the sound paths to the listener H are considered in the present embodiment, the form of using a headphone that directly emits sound to user's ears is effective because the acoustic effect is improved.

Further, although in the reverberation adding apparatus according to the present embodiment, the number of input channels is two and the number of output channels is two, the number of input channels and the number of output channels are not limited to such a form and an appropriate number equal to or larger than one can be employed.

The present disclosure may also be realized by an apparatus, a method, a program, a system, or the like. For example, a program that performs the functions described in the above-mentioned embodiment can be downloaded, and a device that does not have the functions described in the above-mentioned embodiment can perform the control described in the above-mentioned embodiment in the device by downloading the program. The present disclosure can also be realized by a server that distributes such a program. In addition, the matters described in the respective embodiments and modified examples can be combined as appropriate.

The present disclosure may also take the following configurations.

(1) A reverberation adding apparatus, including:
a plurality of paths that constitutes an output channel or a plurality of output channels; and
a convolution operation unit that convolves an impulse response for each of the paths, in which
the impulse response is formed by combining a plurality of reverberation pattern blocks in a time axis direction, the reverberation adding apparatus using the reverberation pattern blocks common to the plurality of convolution operation units.
   (2) The reverberation adding apparatus according to (1), in which
the reverberation pattern blocks common to the plurality of convolution operation units are different in use time position.
   (3) The reverberation adding apparatus according to (2), in which
the reverberation pattern blocks common to the plurality of convolution operation units are multiplied with a coefficient according to the use time position.
   (4) The reverberation adding apparatus according to any one of (1) to (3), in which
the impulse response to be used in each of the plurality of convolution operation units arranged on the paths that constitute the identical output channel has a common permutation of the reverberation pattern blocks.
   (5) The reverberation adding apparatus according to any one of (1) to (4), in which
the plurality of same reverberation pattern blocks are not used in the impulse response.
   (6) The reverberation adding apparatus according to any one of (1) to (5), in which
the same reverberation pattern blocks are not temporally adjacent in the impulse response.
   (7) The reverberation adding apparatus according to any one of (1) to (6), in which
the same reverberation pattern blocks are not temporally adjacent in an addition result in a case where the impulse response is added between the convolution operation units provided on the plurality of paths that constitutes the identical output channel.
   (8) The reverberation adding apparatus according to any one of (1) to (7), in which
the plurality of output channels is provided,
the output channels include the plurality of paths having an identical input channel as an input, and
a combination of the reverberation pattern blocks to be used at the same use time position is in a predetermined relationship in the impulse responses of the convolution operation units provided on the plurality of paths having the identical input channel as the input.
   (9) A reverberation adding method, including:
performing a convolution operation process of convolving an impulse response in a plurality of paths that constitutes an output channel or a plurality of output channels;
forming the impulse response by combining a plurality of reverberation pattern blocks in a time axis direction; and
using the reverberation pattern blocks common to a plurality of convolution operation processes, the plurality of convolution operation processes each being the convolution operation process.
   (10) A reverberation adding program, including:
performing a convolution operation process of convolving an impulse response in a plurality of paths that constitutes an output channel or a plurality of output channels;
forming the impulse response by combining a plurality of reverberation pattern blocks in a time axis direction; and
using the reverberation pattern blocks common to a plurality of convolution operation processes, the plurality of convolution operation processes each being the convolution operation process.

### REFERENCE SIGNS LIST

1 reverberation adding apparatus
11a, 11b, 21a, 21b convolution operation unit
11c, 21c adder

1. A reverberation adding apparatus, comprising:
a plurality of paths that constitutes an output channel or a plurality of output channels; and
a convolution operation unit that convolves an impulse response for each of the paths, wherein
the impulse response is formed by combining a plurality of reverberation pattern blocks in a time axis direction, the reverberation adding apparatus using the reverberation pattern blocks common to the plurality of convolution operation units.

2. The reverberation adding apparatus according to claim 1, wherein
the reverberation pattern blocks common to the plurality of convolution operation units are different in use time position.

3. The reverberation adding apparatus according to claim 2, wherein
the reverberation pattern blocks common to the plurality of convolution operation units are multiplied with a coefficient according to the use time position.

4. The reverberation adding apparatus according to claim 1, wherein
the impulse response to be used in each of the plurality of convolution operation units arranged on the paths that constitute the identical output channel has a common permutation of the reverberation pattern blocks.

5. The reverberation adding apparatus according to claim 1, wherein
the plurality of same reverberation pattern blocks are not used in the impulse response.

6. The reverberation adding apparatus according to claim 1, wherein
the same reverberation pattern blocks are not temporally adjacent in the impulse response.

7. The reverberation adding apparatus according to claim 1, wherein
the same reverberation pattern blocks are not temporally adjacent in an addition result in a case where the impulse response is added between the convolution operation units provided on the plurality of paths that constitutes the identical output channel.

8. The reverberation adding apparatus according to claim 1, wherein
the plurality of output channels is provided,
the output channels include the plurality of paths having an identical input channel as an input, and
a combination of the reverberation pattern blocks to be used at the same use time position is in a predetermined relationship in the impulse responses of the convolution operation units provided on the plurality of paths having the identical input channel as the input.

9. A reverberation adding method, comprising:
performing a convolution operation process of convolving an impulse response in a plurality of paths that constitutes an output channel or a plurality of output channels;
forming the impulse response by combining a plurality of reverberation pattern blocks in a time axis direction; and
using the reverberation pattern blocks common to a plurality of convolution operation processes, the plurality of convolution operation processes each being the convolution operation process.

10. A reverberation adding program, comprising:
performing a convolution operation process of convolving an impulse response in a plurality of paths that constitutes an output channel or a plurality of output channels;
forming the impulse response by combining a plurality of reverberation pattern blocks in a time axis direction; and
using the reverberation pattern blocks common to a plurality of convolution operation processes, the plurality of convolution operation processes each being the convolution operation process.
